(19) United States
(12) Patent Application Publication
(10) Pub. No.: US 2008/0067149 A1
(43) Pub. Date: Mar. 20, 2008

(54) STABILIZER FOR ACIDIC, METAL-CONTAINING POLISHING BATHS

(75) Inventors: Siegfried PIESSLINGER-SCHWEIGER, Vaterstetten (DE); Olaf BOHME, Erding (DE)

Correspondence Address: BORDEN LADNER GERVAIS LLP;Gail C. Silver, 1100-100 QUEEN ST, OTTAWA, ON, K1P 1J9, US

(73) Assignee: POLIGRAT GMBH, Munich (DE)

(21) Appl. No.: 11/857,564

(22) Filed: Sep. 19, 2007

(30) Foreign Application Priority Data
Sep. 19, 2006 (DE) 10 2006 043 880.9

(51) Int. Cl. C23F 3/00; C09K 13/04

(52) U.S. Cl. 216/108; 252/79.2

(57) ABSTRACT

The present invention relates to the use of a mixture of urea and one or more alkane-diphosphonic acids, optionally substituted with one or more hydroxyl or amino groups, or salts thereof for the stabilization of an acidic, metal- and peroxide-containing polishing solution. The invention also relates to peroxide-containing solutions that are suitable for the stabilization of acidic, metal- and peroxide-containing polishing baths, and acidic, peroxide-containing polishing solutions that contain the stabilizer mixture according to the invention. A method of chemical polishing of metal surfaces using the stabilizer according to the invention is also described.

The present invention relates to the use of a mixture for stabilizing an acidic, metal- and peroxide-containing polishing solution. The invention also comprises peroxide-containing solutions that are suitable for the stabilization of acidic, metal- and peroxide-containing polishing baths and which have at least one mixture of urea and one or more alkane-diphosphonic acids. Furthermore, the present invention relates to said acidic and peroxide-containing polishing solutions that contain a mixture as stated above as stabilizer. Finally, the invention also relates to a method of chemical polishing of metal surfaces using an acidic, peroxide-containing solution.

Chemical polishing of metal surfaces is a method for smoothing and deburring metal surfaces. The metal surfaces that are to be polished are treated with oxidizing solutions, generally by dipping in baths of these oxidizing solutions. Said oxidizing solutions are often based on aqueous mixtures of peroxides, in particular of hydrogen peroxide, with inorganic acids or salts thereof, for example ammonium bifluoride (ammonium hydrogen difluoride, NH₄HF₂), and various other additives, such as stabilizers, brightening agents, inhibitors, surfactants and/or viscosity regulators.

Stabilizers are often added to peroxide-containing solutions, as peroxides such as hydrogen peroxide are susceptible to catalytic decomposition in the presence of metals and/or metal ions. Therefore the addition of stabilizers that counteract the decomposition of peroxides is important, especially in solutions that come into contact with metals and/or metal ions, such as peroxide-containing polishing baths in which metal surfaces are deburred and smoothed by oxidation.

A known stabilizer for peroxides is urea, which, according to the state of the art, is added both on its own and in conjunction with other stabilizers, e.g. ammonium ions, to aqueous peroxide-containing solutions.

U.S. Pat. No. 3,122,417 describes the use of alkylidene-diphosphonic acids and other reaction products of phosphorous acid as stabilizer for peroxides and their acid or basic solutions.

All stabilizers used to date have in common, however, that they are only effective up to a certain maximum metal ion concentration. If this upper limit is reached or exceeded, the aqueous peroxide-containing solutions become unstable and there is increasing decomposition of the peroxide with evolution of oxygen. As soon as this critical concentration of metal ions is reached in the aqueous peroxide-containing solution, as a rule these solutions can no longer be used and must be discarded, often at considerable cost, both for the disposal of the old solutions and for the preparation of new, fresh solutions.

The critical upper limits for the content of metal ions depend on the type of metal ions, the composition of the peroxide-containing solutions and the stabilizers used. The values are, for instance, in the range from 10 to 30 g/l for copper and 20 to 40 g/l for iron.

U.S. Pat. No. 4,070,442 discloses synergistic stabilization of hydrogen peroxide solutions containing an organic phosphonic acid derivative and an organic hydroxy compound. This stabilizer mixture is particularly suitable for hydrometallurgy and the separation and cleaning of minerals.

Acidic, aqueous cleaning solutions containing at least one phosphonic acid, at least one oxidizing agent and at least one short-chain organic carboxylic acid are known from DE 4232612 A1. Urea-hydrogen peroxide is mentioned as a possible oxidizing agent. The present invention usually employs urea as such and not in the form of a 1:1 adduct with hydrogen peroxide. However, the stabilization of peroxide-containing solutions is not claimed in this document. Rather, it refers to the removal of magnetite. Phosphonic acids are used essentially for removing the firmly-adhering magnetite deposits. The cleaning solutions described there are regularly used at temperatures in the range from 80 to 100° C. In processes using peroxides such high temperatures are avoided, since peroxides generally undergo autocatalytic decomposition starting from approx. 60° C.

From DE-Offenlegungsschrift (unexamined application) 1519494, stabilizers for solutions of peroxy compounds are known, which in addition to certain aminotriphosphonic acids can also contain urea per-compounds. The solutions regularly have a pH value from about 7.5 to about 12.5. It is stated explicitly that solutions with a pH value of less than 7.5 are not suitable as peroxide bleaching solution, because at lower pH values the bleaching rate becomes so low that economical operation is no longer possible.

CN 1720313 A discloses a paste or slurry that is said to be suitable for the mechanical polishing of metals. In addition to a urea-peroxide, this paste can also contain, among other ingredients, 1-hydroxyethane-1,1-diphosphonic acid as chelating agent. The possibility of stabilization of the pastes or slurry is not mentioned.

A frequent further disadvantage of the stabilizers according to the state of the art is that, even below the critical metal ion concentration, these stabilizers do not completely suppress the decomposition of the peroxides, but only slow it down. For this reason, both during use of the peroxide-containing solutions and during their storage, for instance during quite long pauses in operation, the peroxide concentration of the solution must be checked regularly, and often further peroxide must be added to compensate for the losses through catalytic decomposition. The fluctuations of the peroxide concentration in the solutions due to catalytic decomposition can adversely affect process quality. To avoid this, regular, expensive analytical monitoring of the solutions is necessary.

Many processes in which aqueous peroxide-containing solutions are used, for instance chemical polishing, are exothermic. As a result, the solutions heat up during the process and must therefore be cooled in order to maintain the desired operating temperature. The heating can also result in the critical temperature of the peroxides, at which autocatalytic decomposition of the peroxides—also exothermic—occurs, being reached or exceeded. For aqueous hydrogen peroxide solutions this critical temperature is around 65° C. If this temperature is exceeded, even further addition of stabilizers can no longer effectively keep this autocatalytic decomposition in check. When peroxides decompose in this way, the commercially available stabilizers also lose their effectiveness irreversibly, and the solutions/polishing baths have to be discarded, disposed of and fresh solutions must be prepared.

The invention relates essentially to the use of a mixture of urea and one or more alkane-diphosphonic acids, which are optionally substituted with one or more hydroxyl or amino groups, or salts thereof, for the stabilization of a peroxide-containing solution.

The stabilizing action of said mixture is especially important if it is used for the stabilization of an acidic, metal- and peroxide-containing polishing solution.

It is known that metal ions that form during the execution of a polishing process may accelerate the decomposition of the peroxides. Therefore it was surprising, in the case of the present invention, that in particular both for iron and for copper surfaces, the polishing bath was still usable at high metal concentrations (e.g. >20 g/l).

Polishing baths, in the sense of the present invention, are generally to be understood as aqueous, acidic peroxide-containing solutions. Slurries and pastes, which additionally use mechanical abrasives, are certainly conceivable, but are not a direct object of the present invention.

Other objects of the invention can be seen from the rest of the description and the accompanying claims.

The invention relates to a novel stabilizer for aqueous peroxide-containing solutions, which reliably suppresses the decomposition of the peroxide, largely independently of the concentration of metal ions dissolved in the solution.

A stabilizer according to the invention comprises a combination of urea and one or more alkane-diphosphonic acids, which are optionally substituted with one or more hydroxyl or amino groups, or the salts of these alkane-diphosphonic acids, with the hydrocarbon chain preferably having 1, 2, 3 or 4 carbon atoms. Examples of said alkane-diphosphonic acids are alkylene-diphosphonic acids or amino- or hydroxy-substituted alkylidene-diphosphonic acids. An especially suitable alkylidene-diphosphonic acid is 1-hydroxyethane-1,1-diphosphonic acid.

An especially high effectiveness of this novel stabilizer according to the invention was observed when the weight ratio of urea to free alkane-diphosphonic acids is in the range from 100:1 to 20:1. Preferably said weight ratio is between 60:1 and 35:1, in particular around 50:1.

The stabilizer serves for stabilizing aqueous peroxide-containing solutions. This mainly relates to aqueous hydrogen peroxide-containing solutions, but other peroxide-containing solutions can also be stabilized in this way, for instance solutions that contain per-sulfuric acids and/or peroxy-carboxylic acids, such as peracetic acid, or salts thereof.

The concentration of a stabilized aqueous solution of hydrogen peroxide can be about 30 or 35%, though it can also be lower, for instance <20%, <10% or <5%.

The solutions stabilized with the stabilizer of the present invention are a further aspect of the present invention. These solutions can contain other constituents in addition to the stabilizer, the peroxide or peroxides and water. Peroxide-containing solutions often contain one or more other acids, for instance mineral acids such as hydrochloric acid, sulfuric acid, phosphoric acid, perchloric acid, hydrofluoric acid and/or organic acids such as carboxy acids and sulfonic acids.

The stabilizers can, according to the invention, be added to the aqueous peroxide-containing solutions as pure substance or as solutions. As a rule the stabilizer is used in the solution at a concentration of 0.1 to 3.0 wt. %. Preferably the concentration is between 0.2 and 3.0 wt. %, in particular at around 0.4 to 1.0 wt. % of the aqueous peroxide-containing solution.

The substances urea and alkylidene-diphosphonic acid(s) contained in the stabilizer according to the invention are already known individually as stabilizers and are also used as such. In themselves, however, they display the aforementioned drawbacks of conventional stabilizers.

It was found, surprisingly, that a combination of urea with one or more alkane-diphosphonic acids provides a stabilizer for aqueous peroxide-containing solutions that exhibits novel properties. Thus, a stabilizer comprising a mixture of urea or one or more alkane-diphosphonic acids or salts thereof has the following properties, which are important for a variety of uses, such as when the stabilized solutions are used as chemical polishing baths for the treatment of metal surfaces. The term chemical polishing bath includes not only dipping baths, but all forms of application of the stabilized peroxide-containing solutions intended for the polishing or deburring of metal surfaces on the basis of a chemical reaction of the peroxide.

With the stabilizer according to the invention, aqueous peroxide-containing solutions, such as chemical polishing baths, can be used until saturation with metal ions or until exhaustion of the active substances (such as the optionally added inorganic acid or inorganic acids), without any notable decline in the action of the aqueous peroxide-containing solution, especially its oxidizing action. Furthermore, exhausted solutions can be made fully functional again simply by supplementing the active substances and therefore do not have to be discarded.

Even if the aqueous peroxide-containing solutions overheat, so that autocatalytic decomposition of the peroxides occurs, the stabilizer according to the present invention is generally unimpaired. After the solutions have reacted completely and have cooled to below the critical temperature, after supplementing the peroxide the aqueous solutions can be used again without restriction, and the stabilizing action of the stabilizer is unimpaired.

The stabilizing action of the stabilizer according to the invention is often far greater than that of the individual compounds or other stabilizers according to the state of the art. Thus, it was observed that both during use, for instance as chemical polishing baths in the deburring and polishing of workpieces, and during storage, such as during work breaks, the solutions only lose an insignificant amount of oxygen through decomposition of the peroxides. This ensures economically optimal utilization of the solutions optionally with other added active substances such as inorganic acids.

Owing to the excellent stabilizing action of the stabilizer according to the present invention, expensive organic additives such as ammonium ions become unnecessary. This can lead to a drastic reduction in the costs incurred for the treatment of wastewater and concentrates. Treatment of the used solutions can comprise simple neutralization in conjunction with separation of the metal ions by precipitation. Special treatment of complexes or the incineration of the baths or sludges on account of this ammonium ion content becomes unnecessary.

When the aqueous peroxide-containing solutions are used as a chemical polishing bath for the treatment of metal surfaces, the composition of these polishing baths can be restricted to the active substances acid, peroxide and stabilizer. Addition of other substances is possible, but as a rule is not required, so that a further appreciable reduction in costs becomes possible.

When used as a chemical polishing bath, the rate of removal and the efficiency of the baths can be increased by a considerable amount relative to the methods according to the state of the art, without observing any losses of quality.

These advantages distinguish the stabilizers of the present invention from other stabilizers according to the state of the art. These properties result from an unexpected synergistic effect of the constituents of the stabilizer. The synergistic effect is especially pronounced if the constituents urea and alkane-diphosphonic acid are used in a weight ratio from 100:1 to 20:1.

A further aspect of the present invention relates to methods for the chemical polishing of metal surfaces with a peroxide-containing polishing bath containing the stabilizer according to the invention. Chemical polishing means the smoothing and deburring of metal surfaces by an oxidizing acidic solution. The workpieces whose surfaces can be polished chemically by a method according to the present invention can comprise various metals. The method can be applied for instance to copper-containing metal surfaces, such as with workpieces of copper or copper alloys. The method can also be applied to iron-containing metal surfaces, such as in structures fabricated from carbon steel and soft iron.

In the chemical polishing of carbon steel, in the state of the art a solution is used that contains ammonium bifluoride in addition to the oxidizing agent. When employing a method according to the present invention, ammonium bifluoride can be replaced with hydrofluoric acid at a corresponding concentration. This reduces not only the costs for the constituents that are to be used in the polishing bath, but also the costs incurred in disposal of the ammonium-containing baths and sludges. In addition, in these hydrofluoric acid-containing polishing baths it is possible to achieve far higher processing rates of metal workpieces, which are many times higher than in polishing baths according to the state of the art. Furthermore, a number of other organic additives that are required in conventional baths also become unnecessary.

The method of chemical polishing according to the present invention comprises contacting a metal surface with the stabilized aqueous, peroxide-containing solution in any suitable manner. This can for example be effected by dipping the workpiece in a polishing bath, but also in some other way, for instance by passing the solution through internal spaces that are to be polished or by directed spraying on the surface of a workpiece. If the workpiece or workpieces to be polished are dipped in the aqueous peroxide-containing solution, stirring of the polishing bath is often advantageous. This can reduce the required time of action and provide uniform polishing of the metal surface. The stabilized aqueous, peroxide-containing solution can, if required, contain other additives, such as brightening agents, inhibitors, surfactants and/or viscosity regulators.

Polishing is generally carried out at room temperature or slightly higher temperatures, for instance between 20 and 45° C. The optimal time of action depends on many factors, such as temperature, composition of the solution and of the metal surfaces and the initial roughness of the metal surfaces to be polished, though owing to the stabilizer according to the invention, only to a very limited extent on the metal ion concentration in the solution.

Following the treatment in the polishing bath or after contact with the aqueous peroxide-containing solution, the treated workpiece is usually rinsed with demineralized water and dried.

The invention is explained in more detail in the following examples.

### EXAMPLE 1

### Chemical Polishing Baths for the Treatment of Carbon Steel C 45

A—Polishing bath according to the state of the art:

| | |
|---|---|
| Composition (wt. %): | |
| Ammonium hydrogen difluoride | 0.8% |
| Urea | 1.8% |
| Oxalic acid | 0.5% |
| Hydrogen peroxide (35%) | 10.0% |
| Water | remainder |
| Parameters: | |
| Temperature | 30° C. |
| Iron removal rate (activity): | 50 mg/(dm² min) |

Result:

The surfaces were shiny, and the edges had been deburred.

Working range up to a concentration of 20 g/l of dissolved iron, at higher concentration there was a sharp increase in consumption of hydrogen peroxide. Beyond 30 g/l the bath was no longer serviceable and had to be regenerated by partial replacement. Starting at 25 g/l iron in solution there was increasing precipitation of sparingly soluble deposits (salt coatings).

It was possible to increase the activity by increasing the concentration of ammonium hydrogen difluoride up to an activity of 80 mg/(dm² min). At higher activity the surfaces became matt and rough.

### B—Polishing bath according to the invention

| | |
|---|---|
| Composition (wt. %): | |
| Hydrofluoric acid | 0.7% |
| Urea | 0.7% |
| 1-Hydroxyethane-1,1-diphosphonic acid | 0.02% |
| Hydrogen peroxide (35%) | 20.0% |
| Water | remainder |
| Parameters: | |
| Temperature: | 30° C. |
| Activity: | 200 mg/(dm² min) |

Result:

Smooth, shiny surfaces, edges deburred.

It was possible to increase the activity by increasing the concentration of HF and stabilizer up to 600 mg/(dm² min) without any loss of quality. Moreover, no precipitates were found in the bath. The consumption of hydrogen peroxide did not increase. The bath was serviceable up to an iron concentration of 60 g/l.

The activity of bath (B) relative to bath (A) was up to 8 times higher, with correspondingly shorter times of action and 3 times longer service life. Furthermore, the costs for the chemicals were far lower for bath (B) than for bath (A).

### EXAMPLE 2

### Chemical Polishing Baths for the Treatment of Copper

### A—Polishing bath according to the state of the art

| | |
|---|---|
| Composition (wt. %): | |
| Sulfuric acid (96%) | 1.0% |
| Hydrogen peroxide (35%) | 14.0% |
| Stabilizer (commercially available) | 1.0% |
| Water | remainder |
| Parameters: | |
| Temperature: | 35° C. |
| Removal rate: | 0.1 g/(dm² min) |

Result:

Good shine, edges deburred. Starting from a content of 10 g/l copper, increasing consumption of hydrogen peroxide. Above a copper content of 20 g/l there was a marked decline in quality of the surfaces and sharply increasing consumption of hydrogen peroxide.

### B—Bath according to the invention

| | |
|---|---|
| Composition (in wt. %): | |
| Sulfuric acid (96%) | 1.0% |
| Hydrogen peroxide (35%) | 14.0% |
| Urea | 0.4% |
| 1-Hydroxyethane-1,1-diphosphonic acid | 0.01% |
| Water | remainder |
| Parameters: | |
| Temperature: | 35° C. |
| Removal rate: | 0.1 g/(dm² min) |

Result

Shiny surfaces up to a copper content of 50 g/l. Up to a copper content of 30 g/l in the solution, the consumption of hydrogen peroxide remains constant. At higher concentration there is a slight increase in consumption per hour of operation. This corresponds to a 2.5- to 3-fold service life of the bath according to the invention.

What is claimed is:

1. Use of a mixture of urea and one or more alkane-diphosphonic acids, optionally substituted with one or more hydroxyl or amino groups, or salts thereof for the stabiliztion of an acidic, metal- and peroxide-containing polishing solution.

2. The use as claimed in claim 1, wherein the weight ration or urea to alkane-diphosphonic acid is in the range from 100:1 to 20:1.

3. The use as claimed in claim 1, wherein the alkane-diphosphinic acid comprises 1-hydroxyethane-1,1-diphosphonic acid.

4. The use as claimed in claim 1, wherein the acidic, metal- and peroxide-containing polishing solution has a pH value from 0 to 3.

5. A peroxide-containing solution suitable for the stabilization of acidic, metal- and peroxide-containing polishing baths, comprising a mixture of urea and one or more alkane-diphosphonic acids, optionally substituted with one or more hydroxyl or amino groups, or salts thereof.

6. The solution as claimed in claim 5, wherein the alkane-diphosphonic acid comprises 1-hydroxyethane-1,1-diphosphonic acid.

7. The peroxide-containing solution as claimed in claim 5, wherein the weight ratio of urea to alkane-diphosphonic acids is between 60:1 and 35:1.

8. An acidic, peroxide-containing polishing solution, comprising as stabilizer a mixture of urea and one or more alkane-diphosphonic acids, optionally substituted with one or more hydroxyl or amino groups, or salts thereof.

9. The polishing solution as claimed in claim 8, characterized in that the concentration of the stabilizer in the solution is from 0.1 to 3.0 wt. %.

10. The solution as claimed in claim 8, wherein the weight ratio or urea to alkane-diphosphonic acids is in the range from 100:1 to 20:1.

11. The solution as claimed in claim 8, wherein the solution contains one or more other acids.

12. The solution as claimed in claim 11, wherein the solution contains hydrofluoric acid.

13. The solution as claimed in claim 11, wherein the solution contains sulphuric acid.

14. A method of chemical polishing of metal surfaces with an acidic, peroxide-containing solution at a pH value from 0 to 3, wherein a peroxide-containing solution is used together with a mixture of urea and one or more alkane-diphosphonic acids, optionally substituted with one or more hydroxyl or amino groups, or salts thereof.

15. The method as claimed in claim 14, wherein iron-containing metal surfaces are chemically polished.

16. The method as claimed in claim 15, wherein the aqueous peroxide-containing solution contains hydrofluoric acid.

17. The method as claimed in claim 14, wherein copper-containing metal surfaces are chemically polished.

18. The method as claimed in claim 16, wherein the aqueous peroxide-containing solution contains sulphuric acid.
